(19) United States
(12) Patent Application Publication
(10) Pub. No.: US 2026/0259236 A1
(43) Pub. Date: Sep. 3, 2026

(54) DYNAMIC ROUTING ALGORITHMS FOR MODULAR ANALYZER SYSTEMS

(71) Applicant: Siemens Healthcare Diagnostics Inc., Tarrytown, NY (US)

(72) Inventors: Rayal Prasad, Princeton, NJ (US); Yao-Jen Chang, Princeton, NJ (US); Ankur Kapoor, Plainsboro, NJ (US); Mark Edwards, Armonk, NY (US)

(73) Assignee: Siemens Healthcare Diagnostics Inc., Tarrytown, NY (US)

(21) Appl. No.: 18/994,675

(22) PCT Filed: Jul. 25, 2023
(86) PCT No.: PCT/US2023/028609

§ 371 Date: Jan. 15, 2025

Related U.S. Application Data
(60) Provisional application No. 63/369,755, filed on Jul. 28, 2022.

(51) Int. Cl. G01N 35/04; G01N 35/00

(52) U.S. Cl. CPC G01N 35/04; G01N 35/00584; G01N 2035/00326; G01N 2035/0477

(57) ABSTRACT

Systems and methods for dynamic route planning for use with modular liquid handler systems. A route planning algorithm can be utilized to plan routes for the vessel movers of the liquid handler systems in a dynamic manner, without the need for hardcoded routes, so that a route planning system can efficiently transport samples between modules of the liquid handler systems while minimizing risks of collisions and jams. The route planning algorithm can be configured to receive a representation of the liquid handler system configuration and plan routes for the vessel movers accordingly.

### CROSS REFERENCE TO RELATED APPLICATION

This application claims the benefit of U.S. Provisional Patent Application No. 63/369,755, entitled “DYNAMIC ROUTING ALGORITHMS FOR MODULAR ANALYZER SYSTEMS” filed Jul. 28, 2022, the disclosure of which is hereby incorporated by reference in its entirety for all purposes.

### BACKGROUND

Liquid handler systems and other automated laboratory diagnostic systems are intended to handle a large number of samples at any given time, especially in large-scale reference labs where multiple such systems may be connected by another lab automation network (e.g., Aptio® Automation, FlexLab™ System). In such contexts, the number of sample carriers present on the system may number in the hundreds or even thousands. Once a sample is introduced by loading onto a sample carrier, it is instructed to visit a certain set of destinations (i.e., modules or analyzers). These may be in a particular sequence (e.g., the sample needs to visit centrifuge first and then decapper) and is usually given a time window to do so (e.g., get to analyzer aspiration station in a certain time window). Accordingly, the sample transport system must determine how to get all the sample carriers to their desired destinations while ensuring that the samples don't collide. Furthermore, if time windows are to be adhered to, these samples may need to plan optimal moves (e.g., wait in a location or hover around a certain area) to achieve its goal. Lastly, the sample transport system must attempt to minimize the amount of wear-and-tear on the system by limiting unnecessary or excessive motion.

Traditional liquid handler systems and other laboratory automation systems perform this “routing” by using fixed hard-coded paths within the transport system for individual sample carriers (e.g., hand-crafted paths or algorithmically generated paths using A* or another search algorithm), which is an outdated technique borrowed from traditional manufacturing lines. However, since every sample has a unique worklist, such hardcoded paths and search algorithms are not designed for efficiency. Furthermore, because hardcoded paths are specific to a particular configuration of modules, such techniques are not scalable as every new configuration for a modular liquid handler system would require a completely new set of hardcoded paths.

Another major drawback of traditional systems is that the paths of all carriers on the track are not considered during the planning phase, thus causing the planning to occur in a purely “non-cooperative” manner. In other words, conventional transport control systems generally assume that every sample carrier follows its assigned hardcoded path perfectly and the path of each individual carrier is planned to avoid collisions based on this (often erroneous) assumption. Unfortunately, when carriers behave in this manner without any facet of cooperation (i.e., ensuring that all carriers eventually reach their target destinations), collisions and jams may arise due to invalid sample assignments, which are particularly likely in large automation systems that have hundreds of analyzers/modules and are processing thousands of samples at any given time.

In sum, there are several issues with conventional transport control systems, including inefficiencies in how the track is utilized and the routes are planned, a potential for collisions or jams if any individual carrier fails, and that the route planning software must be customized for each individual system's configuration. Therefore, there is a need in the technical field for route planning techniques for modular liquid handler systems or other sample processing systems that address these and other issues associated with conventional route planning techniques.

### SUMMARY

The present disclosure generally relates to laboratory automation systems and clinical chemistry analyzer systems for use in a laboratory environment. In particular, the present disclosure is generally directed to efficient movement of patient samples in a laboratory automation system.

In one embodiment, the present disclosure is directed to a liquid handler system for processing a liquid sample that includes one or more modules configured to process the liquid sample and a track system interconnecting the modules configured to support one or more vessel movers that include a magnet and receive the liquid sample. A routing control system is configured to receive a representation of a configuration of the modules and the vessel movers associated with the liquid handler system. The routing control system is further configured to determine, using the routing algorithm, a route for each of the vessel movers based on the representation, and to cause the vessel movers to move along the track system between the modules according to the determined route for each of the one or more vessel movers.

In some embodiments, the routing system is further configured to determine whether any additional modules or vessel movers are associated with the liquid handler system, and to receive an updated representation corresponding to an updated configuration of the modules, the vessel movers, and any additional modules or vessel movers associated with the liquid handler system. The routing system can be further configured to determine, using the routing algorithm, an updated route for each of the movers based on the updated representation, and cause the vessel movers and the additional vessel movers to move along the track system between the modules and the additional modules according to the determined updated route for each of the movers and the additional vessel movers. In some embodiments, the representation includes a grid. In some embodiments, the grid graphically indicates locations of the track system, the modules, and the vessel movers.

In some embodiments, the routing control system includes a neural network, which can include an actor-critic network. In some embodiments, the routing control system executes a graph search algorithm, which may include a conflict-based search (CBS) algorithm.

In one embodiment, the present disclosure is directed to a method for performing the above-mentioned functions. An exemplary method of routing one or more vessel carriers associated with a liquid handler system configured to process a liquid sample is one where the liquid handler system includes one or more modules configured to process the liquid sample and a track system interconnecting the one or more modules and is configured to support the one or more vessel movers thereon. The vessel movers include a magnet and are configured to receive the liquid sample. The method includes steps of receiving, by a routing control system, a representation corresponding to a configuration of the modules and the vessel movers associated with the liquid handler system, determining, by the routing control system using the routing algorithm, a route for each of the vessel movers based on the representation, and causing, by the routing control system, the vessel movers to move along the track system between the modules according to the determined route for each of the one or more vessel movers.

### FIGURES

The accompanying drawings, which are incorporated in and form a part of the specification, illustrate the embodiments of the invention and together with the written description serve to explain the principles, characteristics, and features of the invention. In the drawings:

FIG. 1 is a top-down view of an exemplary sample handling module, in accordance with at least one aspect of the present disclosure.

FIG. 2 is a perspective view of an exemplary sample handling module in accordance with at least one aspect of the present disclosure.

FIG. 3 is a diagrammatic view of an exemplary integral, modular automation track system, in accordance with at least one aspect of the present disclosure.

FIG. 4 is a perspective view of an exemplary automation track system, in accordance with at least one aspect of the present disclosure.

FIG. 5 is a perspective view of an exemplary automation track system, in accordance with at least one aspect of the present disclosure.

FIG. 6 is a cross sectional view of an exemplary automation track system, in accordance with at least one aspect of the present disclosure.

FIG. 7 is a top-down view of an exemplary automation track system, in accordance with at least one aspect of the present disclosure.

FIG. 8 is a diagram of a track segment of a liquid handler system, in accordance with at least one aspect of the present disclosure.

FIG. 9 is a diagram of a vessel mover actuator, in accordance with at least one aspect of the present disclosure.

FIG. 10 is a diagram of a liquid handler system having a routing control system, in accordance with at least one aspect of the present disclosure.

FIG. 11A is a perspective view of an illustrative configuration for a modular analyzer system, in accordance with at least one aspect of the present disclosure.

FIG. 11B is a perspective view of another illustrative configuration for a modular analyzer system, in accordance with at least one aspect of the present disclosure.

FIG. 11C is a perspective view of yet another illustrative configuration for a modular analyzer system, in accordance with at least one aspect of the present disclosure.

FIG. 12 is a diagram of the track system of the modular analyzer system configuration shown in FIG. 11, in accordance with at least one aspect of the present disclosure.

FIG. 13 is a flow diagram of a process for dynamically planning routes for vessel movers in a modular liquid transport system, in accordance with at least one aspect of the present disclosure.

FIG. 14 a grid representation of a liquid handler system configuration as input for the route planning algorithm, in accordance with at least one aspect of the present disclosure.

FIG. 15 is a diagram demonstrating a conflict-based search (CBS) algorithm, in accordance with at least one aspect of the present disclosure.

FIG. 16 is a representation for a liquid handler system configuration including a temporal dimension, in accordance with at least one aspect of the present disclosure.

FIG. 17 is a diagram demonstrating a field of view (FOV) used for training a neural network for dynamically planning routes for vessel movers in a modular liquid transport system, in accordance with at least one aspect of the present disclosure.

FIG. 18 is a diagram of an actor-critic network, in accordance with at least one aspect of the present disclosure.

### DESCRIPTION

This disclosure is not limited to the particular systems, devices, and methods described, as these may vary. The terminology used in the description is for the purpose of describing the particular versions or embodiments only, and is not intended to limit the scope.

As used herein, the terms “algorithm,” “system,” “module,” “engine,” or “architecture,” if used herein, are not intended to be limiting of any particular implementation for accomplishing and/or performing the actions, steps, processes, etc., attributable to and/or performed thereby. An algorithm, system, module, engine, and/or architecture may be, but is not limited to, software, hardware and/or firmware, or any combination thereof, that performs the specified functions including, but not limited to, any use of a general and/or specialized processor in combination with appropriate software loaded or stored in a machine readable memory and executed by the processor. Further, any name associated with a particular algorithm, system, module, and/or engine is, unless otherwise specified, for purposes of convenience of reference and not intended to be limiting to a specific implementation. Additionally, any functionality attributed to an algorithm, system, module, engine, and/or architecture may be equally performed by multiple algorithms, systems, modules, engines, and/or architectures incorporated into and/or combined with the functionality of another algorithm, system, module, engine, and/or architecture of the same or different type, or distributed across one or more algorithms, systems, modules, engines, and/or architectures of various configurations.

### Automated Liquid Handler Systems

A liquid handler or liquid handling robot is a system that is designed to dispense and process any type of liquid, including reagents and patient samples. Liquid handles are particularly adapted to automate workflows in life science laboratories, such as clinical laboratories or research laboratories. Some liquid handlers, which can be referred to as “analyzers” or “analyzer systems” are additionally adapted to process and perform tests on samples using, for example, immunoassay and/or clinical chemistry techniques.

Liquid handlers can include automation systems, either integrally or as modules coupled to the liquid handlers. Some liquid handler systems can include a number of modules or stations that are adapted to perform different tasks or tests. In these embodiments, the automation systems can include a transport system that is adapted to transport containers of samples and/or reagents between the various modules or stations. As noted above, transport systems can include friction-based movement systems, conveyor belts, and magnetically driven movement systems. Automation systems can further include sensor assemblies for detecting parameters associated with the containers or other aspects of the transport systems and control systems that are configured to control the movement of the containers accordingly.

In some embodiments, liquid handler systems can utilize a modular system including an automated clinical chemistry analyzer module and an automated immunoassay analyzer module, with sample loading capability to transport patient samples to and from analyzer module(s) where in vitro diagnostic assay analyses are performed. The system can be scalable in multiple configurations of the modules allowing customer yearly throughput needs ranging from low volume to very high volume/mega market segments (i.e., 500,000 to 5 M or more tests per year).

In some embodiments, the automation system can be described as a process control manager (PCM) that manages the processing of samples. This includes providing input and output for samples into and out of the system, temporary storage of samples while awaiting processing, scheduling of samples for processing at various analyzers attached to the PCM, facilitation of the movement of samples throughout an automation track (including onto and off of the automation track), and, in some embodiments, maintenance of the automation systems. In various embodiments, a PCM can include a variety of different modules, including a sample handler and a vessel mover.

The sample handler provides a means for the user to load and unload regular samples, STAT samples, and control/calibrator vials onto and off of the system. Within the sample handler, the robot subsystem is responsible for moving these tubes between other subsystems and modules, including the sample I/O (drawer trays), control storage, and the vessel mover.

The vessel mover subsystem handles this material distribution. Under normal conditions, a lab technician never operates the vessel mover track directly. The vessel mover manages carriers on an automation track that moves samples or reagents, each carrier having a dedicated type of holders. In some embodiments, liquid handler systems can include reagent carriers that are configured to accept a reagent cartridge and to transport the reagent cartridge, via the automation track, to a location accessible to the one or more analyzer modules. In some embodiments, a reagent carrier can be adapted to handle reagents from both an immunoassay module and clinical chemistry module.

FIG. 1 shows a top-down view of an exemplary sample handler 10 that may be used for some embodiments. Within this figure, sample handler 10 is oriented so that the front (i.e., the face that the operator interacts with) is at the bottom of the page, while the back of the automation track is located at the top of the page. Sample handler 10 includes a tube characterization station 12 at the robot/track interface. Tube characterization station 12 characterizes tubes and carriers when tubes are placed on carriers on track 14. This allows information to be ascertained about the identity of the tube placed in each carrier, and the physical condition of each tube (e.g., size of the tube, fluid level, whether there is a tube top cup, etc.) Adjacent to the tube characterization station 12 sits a control/calibrator storage region 14. This allows long-term refrigerated storage of control and calibrator fluids near the track, allowing these fluids to be easily placed into carriers on the track for movement to relevant locations in the analyzer. The location of storage 16 also allows input/output drawers 18 to be placed in the front of sample handler 10. In this example, there are four adjacent drawers 18 that can be individually opened and pulled out.

A robot arm 20 can move in two dimensions to pick up any of the tubes in drawers 18 and move those tubes to and from storage 16 and carriers on track 14. Robot arm 20 can be positioned by moving a gantry from the front to the back of a sample handler 10 while a carriage moves side to side along that gantry. Opposable end effectors can then be moved vertically to reach down to pick up tubes, closing the end effectors when they are properly positioned to engage the tube.

To assist the robot arm 20 in successfully engaging each tube, a drawer vision system 22 is placed above the drawers at the opening to the drawers. This allows a series of images to be taken, looking down at the tubes in the trays, as the trays are moved past the drawer vision system. By strobing a series of cameras, multiple images can be captured in a buffer, where each tube appears in multiple images. These images can then be analy zed to determine the physical characteristics of each tube. For example, diameters and heights of each tube can be determined. Similarly, the capped or uncapped states of each sample can be quickly determined. Furthermore, the presence or absence of a tube top cup (a small plastic well that is placed on top of a tube to allow a tube to transport a much smaller volume with greater depth of the sample, to allow aspiration to more easily take place) can be ascertained. Similarly, the characteristics of any cap can be ascertained by the images. This can include certain color markings on the cap to identify a given sample as a higher priority (STAT) sample.

The module manager PC can utilize this information to schedule samples to be moved from each tray in drawers 18 into carriers on track 14. The module manager PC can also instruct robot arm 20 how to interact with each tube, including identifying the proper height for the end effectors before engagement, and the proper force or distance to use when engaging the end effectors to accommodate multiple diameters of tubes.

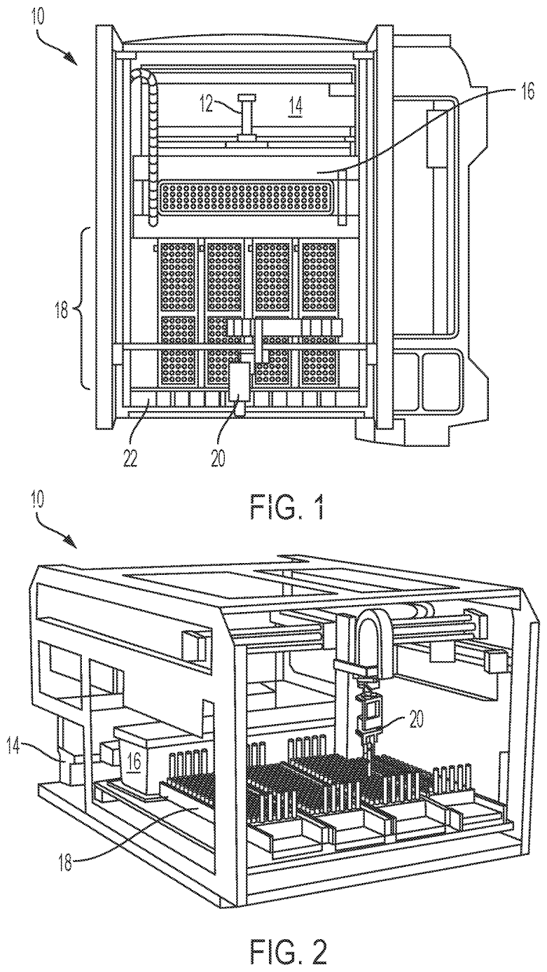

FIG. 2 is a perspective view of a sample handler 10. In this example, track 14 is roughly parallel with the front face of drawers 18, while refrigerated storage 16 is a large physical object between drawers 18 and track 14. Meanwhile, robot arm 20 is moved on supports, well above the height of drawers 18 and refrigerated storage 16. In some embodiments, the sample handler 10 can include a tube characterization station 12 and a drawer vision system 22; however, these stations are omitted from the view in FIG. 2 in order to allow the internals of sample handler 10 to be better understood.

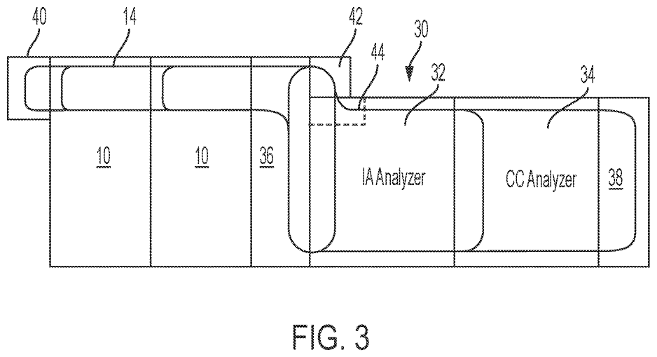

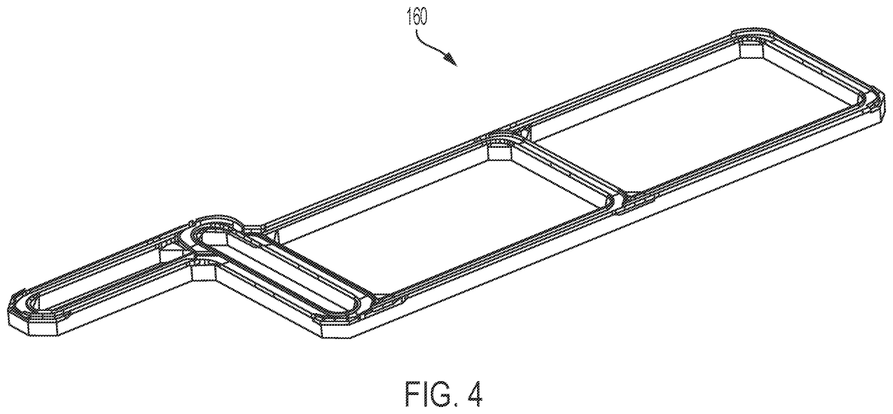

FIG. 3 illustrates the vessel mover components of the PCM that moves samples from an input region to analyzer modules, assists in handling those samples within the analyzer, and returns process samples to the output region of the sample handler. Multi module analyzer system 30 includes multiple interconnected modules. In this example, system 30 includes multiple sample handlers 10. By utilizing multiple sample handlers, more sample trays can be placed into the system, allowing a larger batch to be started at the beginning of the shift. Furthermore, this allows twice as many samples to be placed onto, and taken off of, the track. This means that, for larger systems with multiple analyzer modules that can operate in parallel, input/output throughput can match the analysis throughput of the parallel analyzers. For example, if an analyzer module can handle 500 samples per hour, and three analyzer modules are used, the input/output demand for feeding these modules may be up to 1500 samples per hour. In some embodiments, a single sample handler may not be able to handle this demand, necessitating adding multiple sample handlers to keep up with the input/output demand of the analyzer modules.

Furthermore, in some embodiments, one of the sample handlers can be set up to be used as an input, while the other sample handler can be set up as an output. By using a modular approach, a single sample handler 10 can be used but, for larger systems, two or more sample handlers can be used.

In an exemplary system 30, two analyzer modules are utilized. Analyzer module 32 is an immunoassay (IA) analyzer. Analyzer module 34 is a clinical chemistry (CC) analyzer. These two analyzer modules perform different assays, testing for different characteristics of patient samples.

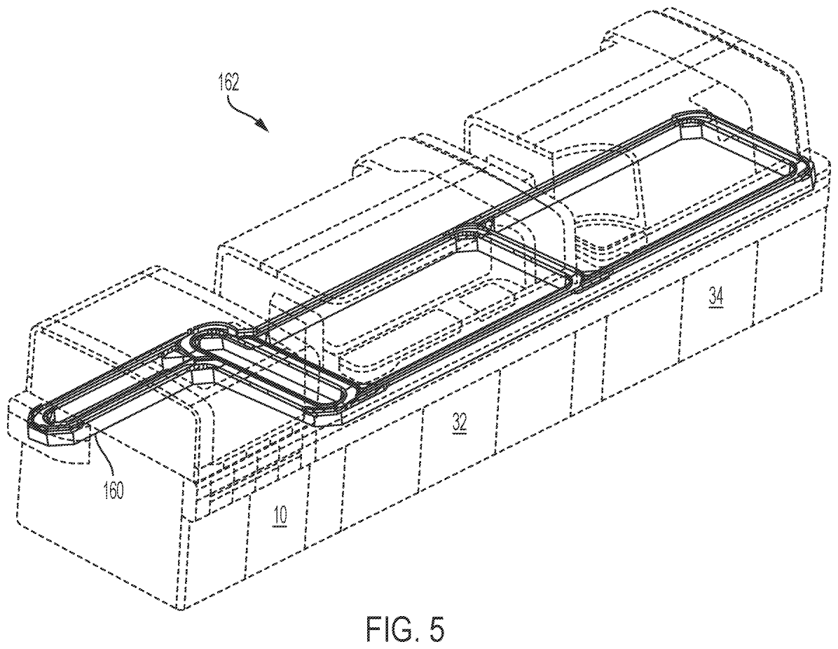

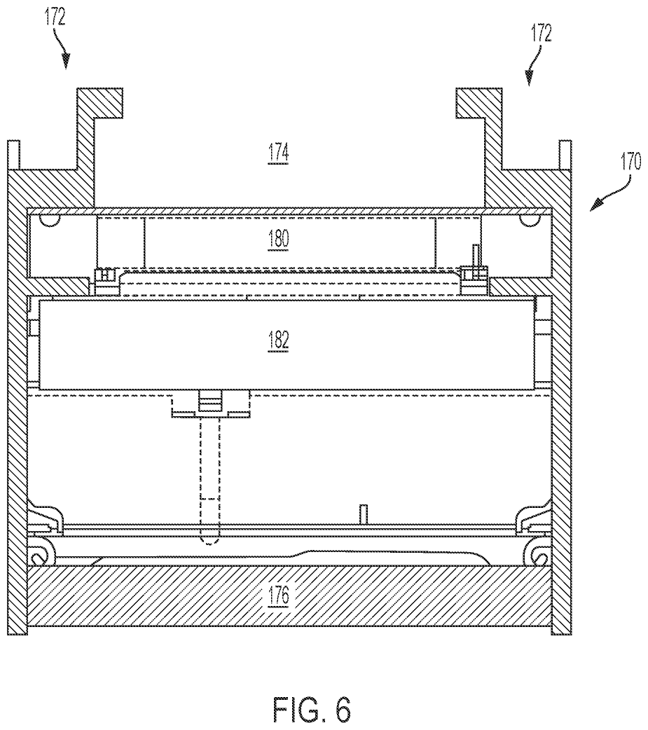

Track 14 is a multi-branching track that forms the heart of the vessel mover system. As can be seen, track 14 comprises branches and lengths that are provided integral to sample handlers 10 and analyzer modules of 32 and 34. The functions of the individual branches will be explained with respect to FIGS. 5 and 6. In addition to the track segments provided by these modules, additional modules 38, 40, and 42 provide short, dedicated track sections that may be bolted to the track portions provided by the other modules. Track modules 36, 38, 40, and 42 provide powered track segments, without additional hardware related to sample handler modules or analyzer modules. Whereas modules 10, 32, and 34 may be full cabinets extending from a laboratory floor to the height of track 14, and above, track segment modules 36, 38, 40, and 42 may be bolt-on segments that extend from the cabinets of the other modules, without requiring floor-length support. Each of the modules in FIG. 3 can be bolted together in modular fashion, utilizing leveling hardware, such that each track segment between adjacent modules forms a virtually seamless track for carriers to traverse the vessel mover system.

In exemplary system 30, it can be seen that section 44 of the track of analyzer module 32 may need to be altered from the corresponding section of analy zer module 34. In some embodiments, the track segments of analyzer modules are in the same configuration as that shown in analyzer module 34 when they are shipped from the factory. This allows multiple analyzers to be placed in series, simply bolting their respective track segments together to form a long chain. In some embodiments, where there is an offset between the back track segment of the sample handler modules and the analyzer modules, as is illustrated in system 30, an S-shaped bend may be needed to allow carriers to move from the back track section of analyzer modules to the back track section of the sample handler modules. In this example, this S-shaped bend is provided by bolting on track section 42 and the altered track segment in area 44. Thus, it should be understood that the track segments within analyzer modules, while integral to those modules, can be extensively modified at the time of installation, allowing multiple configurations of the track segments within an analyzer module. However, it should be understood that these track segments are still very much integral to those analyzer modules. In some embodiments, the back of analyzer modules 32 and 34 are flush with the backs of sample handlers 10, eliminating the need for altering track segment 44 and section 42, entirely.

Track segments 38 and 40 are U-shaped track segments that provide returns between front track segments and back track segments, allowing traffic to move around the track 14 without traversing interior chord segments within sample handler or analyzer modules. This allows the track 14 to form an outer loop, with main traffic moving along the perimeter of the analyzer modules. Meanwhile, the internal track sections bypass the main loop, providing a direct path between two sides of each analyzer module (front to back), which serves as a route for local traffic. These chord segments can also be referred to as internal segments/track sections, bypass segments/track sections, or, in some cases, local track sections. These chord segments bypass the outer loop to provide access to a pipette. This allows small physical queues relevant to each sample handler or analyzer module to utilize those interior chord segments, without blocking the overall flow of track 14.

A specialized track segment module 36 facilitates sample return and branching within track 14 to allow the central computer system of the PCM to direct traffic in flexible ways. The outside track portions provide a way for samples to move from sample handler modules 10 to track segments of analyzer module 32, and vice versa. Meanwhile, the inner chord of track segment module 36 provides a branch whereby samples can move from analyzer 32 to analyzer 34 (in a counterclockwise manner), without moving into sample handler modules 10. This facilitates multiple tests on a single sample tube, allowing sample tubes to freely move between analyzer modules, regardless of how they are arranged on the right-hand side of system 30. This gives the PCM scheduling software flexibility in how samples order the tests within analyzer modules, without increasing traffic on the track segments relating to sample handling. Track segment 36 provides a boundary between sources and sinks (e.g., sample handler modules 10) and processors (e.g., analyzer modules 32 and 34) by providing a branching loop within section 36 (and section 42, in some embodiments). This loop allows sample carriers to move between the sources, sinks, and processors, including allowing samples to loop without returning to the sources and sinks.

Not shown in FIG. 3 is the central computer that includes a system instrument manager software component. The instrument manager software consolidates information from lower-level modules, such as sample handler 10 and analyzer modules 32 and 34, to present this information to an operator. The instrument manager receives information from the other modules via a network within the system (e.g., an internal Ethernet network). Information may be requested and provided asynchronously between the modules and central computer. The central computer can also work between the LIS and vessel mover systems to schedule samples and their movement within the system. The central computer can also work between the vessel mover systems and individual modules to handoff control of the samples and to initiate testing of samples once they arrive at a location.

Additional information regarding in vitro diagnostics systems can be found in U.S. patent application Ser. No. 16/319,306, published as U.S. Patent Application Pub. No. 2019/0277869A1, Titled Automated Clinical Analyzer System and METHOD, filed Jan. 18, 2019, which is hereby incorporated by reference herein in its entirety.

### PCB-Based Automation Track Configurations

Various liquid handlers can include a variety of different transport systems, including magnetic drive systems, friction-based track systems, or conveyor belts. For example, some liquid handlers include a track having a plurality of synchronously controlled magnetic coils. In these analyzer systems, the automation track is configured to move the sample carriers via synchronously controlled magnetic coils that propel the sample carriers along the analyzer system's track sections. However, conventional magnetically driven transport systems use metallic substrates for the automation track. Metallic substrates have several disadvantages, including cost and weight, as generally discussed above. Various embodiments can be applied to any of these above-mentioned transport systems. Some embodiments of transport systems described herein include PCB-based substrates for the automation track. In these embodiments, each track segment can include one or more PCBs and coil arrays that are configured to electromagnetically actuate the vessel mover to transport the vessel mover therealong.

In some embodiments, track sections are divided up into a number of coil boards. A coil board includes a linear array of coils that can be mounted the PCB substrate of the track. For straight sections of track, each coil board is straight, while, in corners or curves, coil boards include appropriately laid out coils to match the curve. All coil boards are controlled by master boards and node controllers. In some embodiments, each master board can control up to eight different coil boards. Meanwhile, a node controller is centralized. A single node controller can control the entire vessel mover track. In some embodiments, multiple distributed node controllers can be used for expandability. For example, in larger systems, where the track extends for several meters, multiple node controllers may be used, and control of carriers can be handed off as they traverse different regions of the track network.

FIG. 4 shows a perspective view of track system 160. Track system 160 is configured to have a single sample handler unit and two analyzer modules. FIG. 5 shows track system 160 situated in a fully operational analyzer system 162 that includes a sample handler module 10 and two analyzer modules of 32 and 34. As can be seen, track system 160 is housed within the modules themselves, such that the track is not easily accessible to an operator. However, track 160 and analyzer system 162 utilize a modular design whereby track components reside within each module and each module can easily be linked together to join the track segments by placing adjacent modules in proximity and linking them. Lids above track 160 can be removed during installation or service to facilitate linking of tracks. In some embodiments, track sections are expanded by placing modules adjacent to one another and bolting the track sections of each module together forming a single multi-branching track system, such as track 160. Signaling cables can be daisy-chained together for ease of expanding control.

FIG. 6 shows a cross-sectional view of the track section 170. Track section 170 may be track section used in track 160. In this embodiment, carriers ride between rails 172 on a track surface 174. In some embodiments, rails 172 are aluminum extrusions that also include vertical sides on the exterior of the track components underneath track surface 174. These aluminum extrusions can include brackets to easily bolt internal components to these side pieces to form a track unit. In the embodiments described herein, the track surface 174 is a PCB. In various embodiments, the PCB track surface 174 can include one or more coatings or other components. At the bottom of the side components of rails 172 resides a baseplate 176. Baseplate 176 can be mounted to the modules containing track section 170 and provide support for the track system.

Beneath track surface 174 reside a series of coils 180. The longitudinal direction of track section 170 is into the page; as you travel along the track section 170, you encounter additional coils 180. Coils 180 are preferably mounted to coil boards 182 and are preferably laterally oblong to allow more coil density in the longitudinal direction of the track. In some embodiments, coil boards 182 are printed circuit boards (PCB) that include several coils 180 in the longitudinal direction. An exemplary coil board is 250 mm in length, accommodating all of the coils 180 needed for 250 mm of track. Thus, a typical track section will have several coil boards 182, including dozens of coil boards 182 to make up an entire track system. In some embodiments, coil boards 182 receive a control signal to indicate the trajectory to apply to a carrier traveling along that coil board and a power source of 24 VDC. Coil boards 182 include coils 180, motor drivers to drive those coils, and one or more sensors to detect the presence of carriers traversing the track surface above the coil board by detecting the magnets of the carrier. These sensors can include Hall Effect sensors to detect the presence and location of the carrier traveling along the coil board. Accordingly, there may be more sensors than coils, allowing fine resolution of the position of a carrier traversing track surface 174. Furthermore, an RFID receiver may be utilized to receive an RFID signal that identifies the carrier traveling along the track surface. In some embodiments, magnetic signatures unique to each carrier can be detected by the Hall Effect sensors to determine the identity of the carrier magnetically. For example, a carrier traversing an array of Hall Effect sensors can be characterized at manufacturing to identify a unique signature of that carrier based on rise times and signal artifacts that are detected by the Hall Effect or sensor array as magnets in the carrier travel over that array. In some embodiments, smaller magnets than the main drive magnets may be placed in the bottom portion of a carrier to intentionally create a unique signature for each carrier at manufacturing. This magnetic signature can be correlated to an identity of each carrier in software for the vessel mover system. An exemplary linear synchronous motor drive system is described in U.S. Pat. No. 9,346,371.

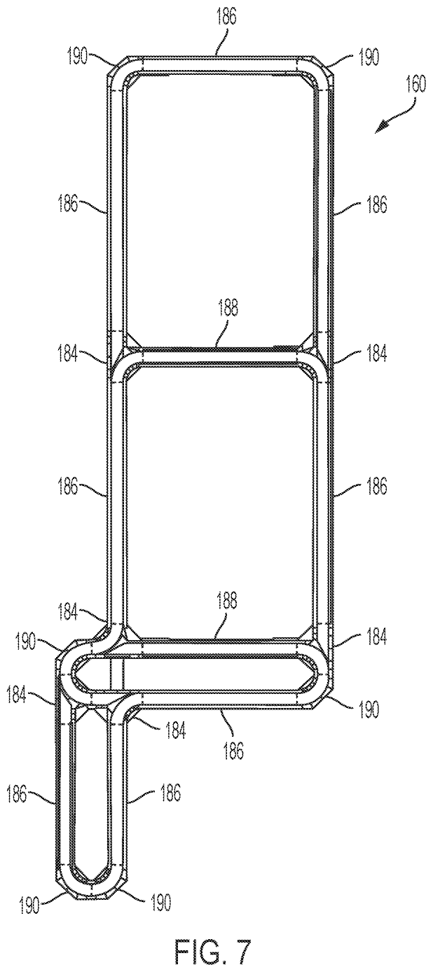

FIG. 7 shows a top view of an exemplary track system 160 with the individual track sections identified. There are generally four types of track sections that make up the modular design of track system 160. Switching segments 184 are branches in the track. The track surface for switching segments 184 is generally T-shaped, with rounded inside edges. Meanwhile, the rails of switching segments 184 include one straight rail (top of the T), one radiused rail (one inside corner of the T), and one radiused rail that includes a switching mechanism (other inside corner of the T). This switching mechanism is a movable rail component that can be turned a predetermined number of degrees to act as a switch (e.g., 20-30 degrees, depending on geometry). On one side of the rail component, it acts as a straight rail. On the other side of the rail component, the rail presents itself as a radiused rail forming an outside corner of a turn. By switching a movable rail component, that movable rail component can either provide the outside of a turn, or a simple straightaway rail. Thus, the mobile component provides a binary switch whereby switching segment 184 presents itself as a turn or as a straightaway, depending on the control signal. This can be used to divert individual carriers based on the state of the switching segment. It should be noted that, while the track may be bidirectional, only one end of the T can be connected to the center portion of the T to form a turn. Thus, while switching segments 184 may have three ports, essentially, one port may be switched to either of the other two ports, but those two ports cannot be joined together.

A simpler type of track section is a straightaway, such as outside straightaway 186 or inside straightaway 188. The basic components of straightaways 186 and 188 are a track surface and rails, with a series of coil boards providing linear motive forces along the direction of that straightaway. Straightaways 186 and 188 are identified separately in FIG. 7 because inside straightaways 188 can be operated under the control of the local module, rather than a vessel mover controller that controls the entire track 160, in some embodiments. This allows each local module to independently operate track sections 188 to act as a local random-access queue. The vessel mover controller can hand off control to the local module after moving a carrier from a switching segment 184 to the local inside straightaway 188. Similarly, when a local module has completed aspirations on a sample residing on inside straightaway 188, that module may move the sample carrier into a switching segment 184 and hand off control to the vessel mover controller. In some embodiments, inside track sections 188 still operate under the control of the vessel mover controller that controls the entire track system 160. To control a local queue on inside straightaway 188, the local module can communicate directly with the vessel mover controller to request movement of carriers within track section 188. This allows the local module to manifest control over carriers in its queue by using a request to acknowledge the communication system, allowing the vessel mover controller to have expertise in moving individual carriers and operating track system 160.

A fourth type of track segment is a curved track segment 190. Curved track segment 190 provides a 90° bend with a predetermined radius (or other angular bend). This radius is preferably the same as the radius used in turns when switching track segments 184 are switched into a curve. The radius is chosen to minimize the space impact of curves while, at the same time, allowing carriers to move quickly around curves without encountering drastic lateral forces. Thus, the space requirements and speed requirements of automation track 160 can determine the radius of curved segments 190.

Electrically, curved segments 190 are substantially the same as straightaways 186 and 188. Each of these segments includes a plurality of coils that are activated, in sequence, to provide a linear motor in conjunction with magnets in the bottoms of carriers. Each coil is activated to provide a push or pull force on drive magnets placed in the bottom of each carrier. The speed at which coils are activated in sequence determines the speed of the carrier on that section of track. Furthermore, carriers may be moved into a position and stopped at a predetermined location with high resolution by activating coils at that location.

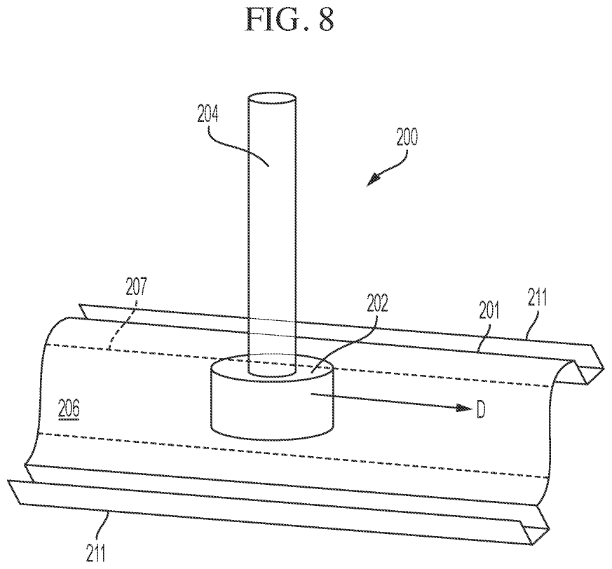

FIG. 8 shows an illustrative embodiment of a track segment 201 of an automation track system 200, such as the track system 160 as shown in FIGS. 4-7. As generally described above, the automation track system 200 is configured to support one or more vessel movers 202, which are configured to receive a vessel 204 (also referred to as a “carrier” or “sample carrier”) therein. The track segment 201 can include a riding surface 206, which is the upper surface of the track segment 201 that supports the vessel mover 202 thereon and along which the vessel mover 202 is transported between the modules or components of the automation track system 200. In some embodiments, the riding surface 206 can include an active region 207 that the vessel mover 202 is intended to move along. As shown, the active region 207 is the area between the dashed lines. The active region 207 can generally correspond to the medial portion of the riding surface 206. If any liquid contaminants are present on the active region 207, they could negatively impact or otherwise impair the movement of the vessel movers 202, as noted above. In some embodiments, the track segment 201 could include a PCB substrate, as generally described above.

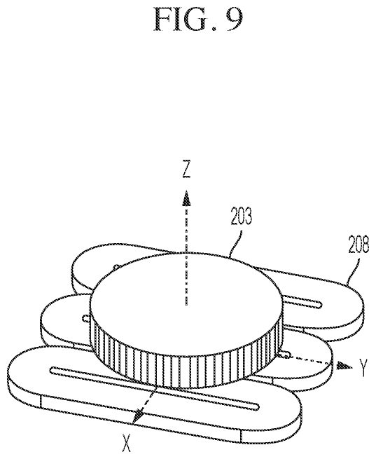

Further, as shown in FIG. 9, the track system 200 can include one or more coil arrays 208 associated with each track segment 201. The coil arrays 208 can be configured to generate a magnetic field that interacts with the magnet 203 positioned within the base of the vessel movers 202. The coil arrays 208 and the vessel mover magnet 203 can collectively define a linear electromechanical actuator. By synchronously controlling the coil arrays 208, the track system 200 can propel the vessel movers 202 (and, thus, the vessels 204 containing any samples or other liquids held thereby) across the track segments 201 to the desired module or other component of the liquid handler system.

Additional information regarding transport systems for liquid handlers can be found in U.S. patent application Ser. No. 16/319,306, which is incorporated by reference above.

### Dynamic Routing Control

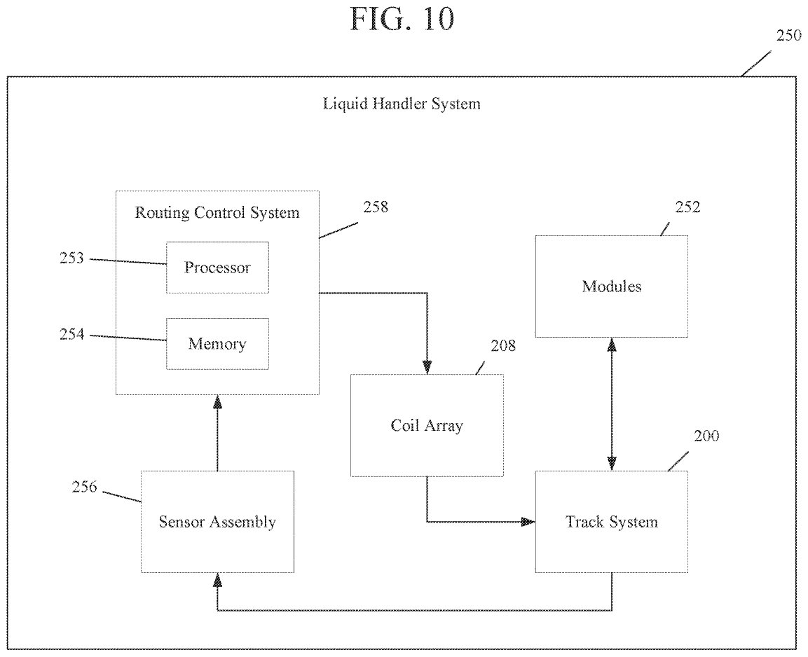

As generally described above and shown in FIG. 10, liquid handler systems 250 can include a track system 200 interconnecting the various modules 252. The track system 200 can be further configured to support and move various vessel movers, which can in turn carry samples to be processed by one or more of the various modules 252. In some embodiments, the liquid handler system 250 can further include a sensor assembly 256 having one or more sensors that are configured to identify and track the movement of the vessels and/or vessel movers as they are moved between the modules 252 across the track system 200. As generally described above, samples must be routed to and between the various modules 252 in particular sequences and/or within particular time windows in order to be processed correctly and/or in an efficient manner. Accordingly, liquid handler systems 250 can include a routing control system 258 that is configured to control the track system 200 and/or the vessel carriers in a manner that allows the samples to be supplied to the modules 252 in the proper sequences and within the proper time windows.

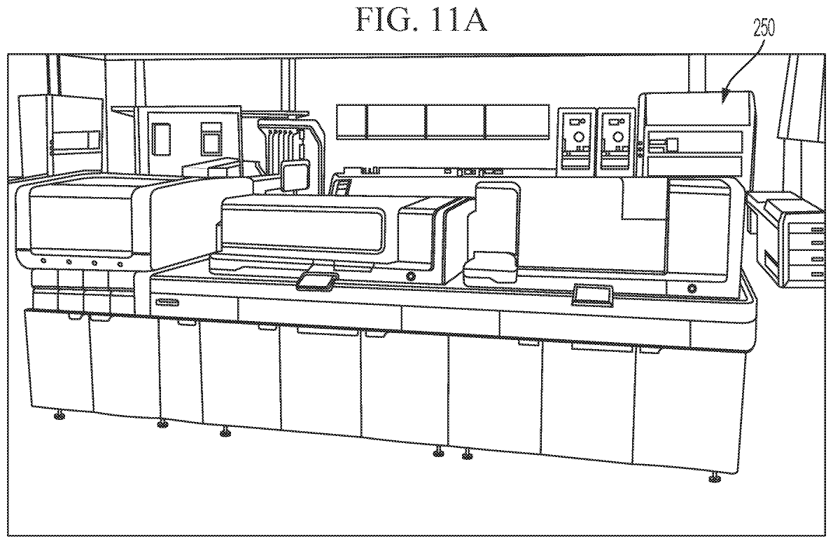

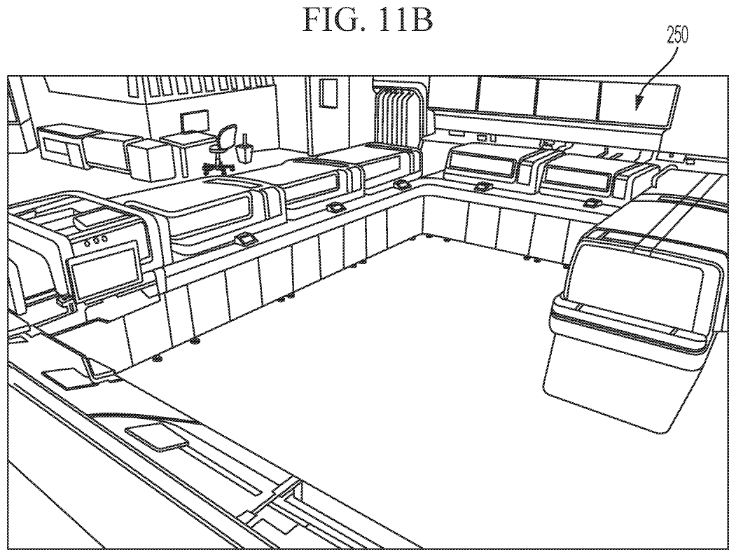

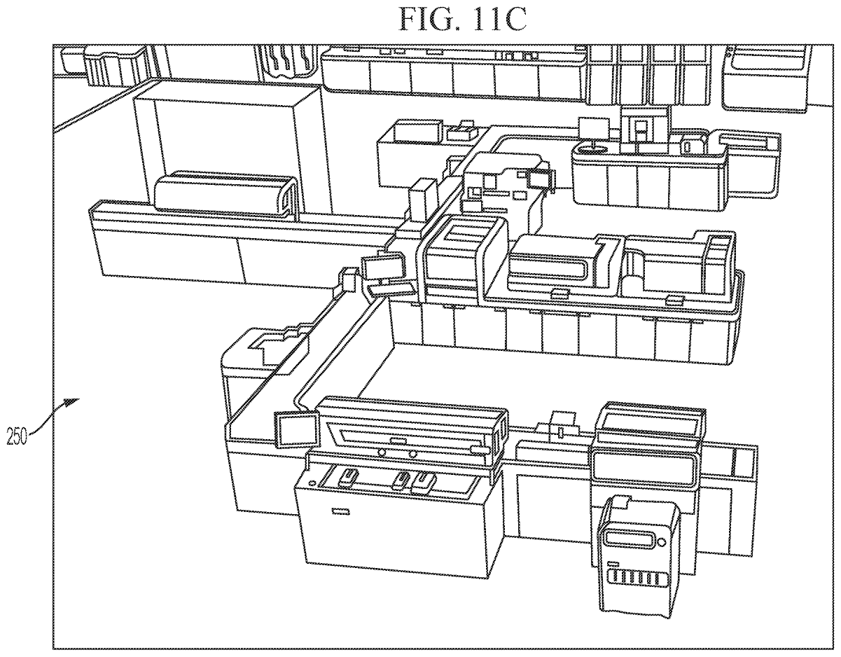

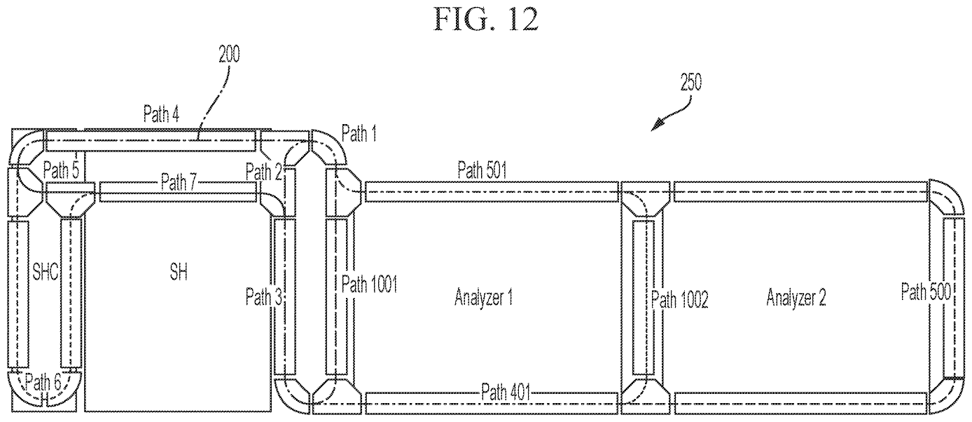

As described above, the liquid handler system 250 can be modular, i.e., include a number of modules 252 that can be combined together in a variety of different configurations. These configurations could include different numbers of modules 252, different types of modules 252, and different arrangements of the modules 252. To illustrate, FIG. 11A shows a liquid handler system 250 having three modules 252 that are arranged in a linear configuration. Further, FIG. 11B shows a liquid handler system 250 having several modules 252 that are arranged in a generally C-shaped configuration. Still further, FIG. 11C shows a liquid handler system 250 having several modules that are arranged in a generally E-shaped configuration. Further, the track system 200 can be arranged in a variety of different configurations based on the number, types, and arrangement of the modules 252. For example, FIG. 12 shows one possible arrangement for the track system 200 for the embodiment of the analyzer system 200 shown in FIG. 11A where three modules 252 are arranged in a linear configuration. In this particular embodiment, the modules 252 include a sample handler (SH) and a pair of analyzers and, accordingly, the track system 200 is arranged to transport samples from the SH module to one or both of the analyzer modules and then back to the SH module. However, other embodiments could have different configuration for the automation rack 204 depending on the types of modules 252.

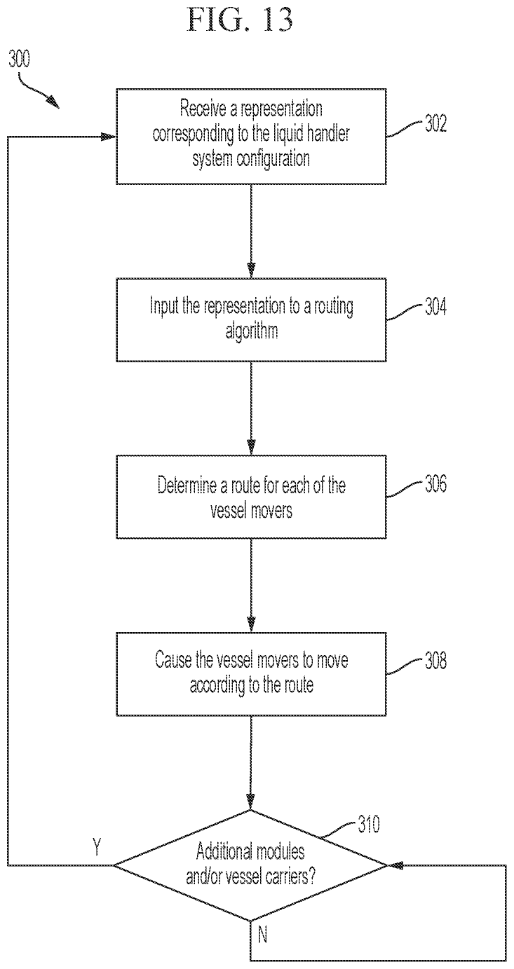

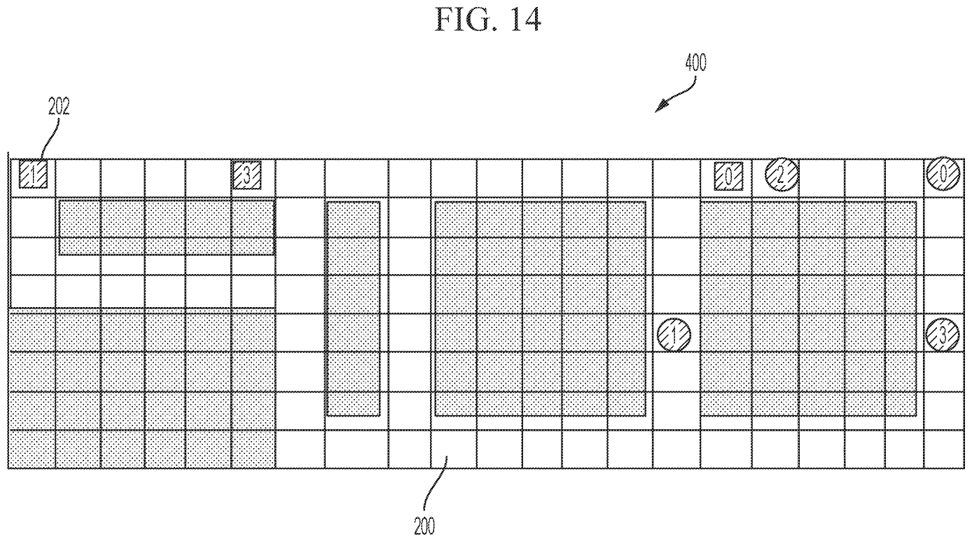

In various embodiments, the routing control system 258 could be embodied as hardware, software, firmware, or various combinations thereof. In the embodiment shown in FIG. 10, the routing control system 258 could me embodied as a computer system executing various algorithms or processes configured to control the transport of the samples between the modules 252 or otherwise throughout the liquid handler system 250. Accordingly, the routing control system 258 could include a processor 253 coupled to a memory 254 that stores instructions, such as routing algorithms, that are configured to control the movement or transport of samples throughout the liquid handler system 250. One example of a route planning algorithm is illustrated in the process 300 shown in FIG. 13. In one embodiment, the process 300 could be embodied as instructions stored in the memory 254 that, when executed by the processor 253, cause the routing control system 258 to perform the process 300 and/or the steps or functions thereof.

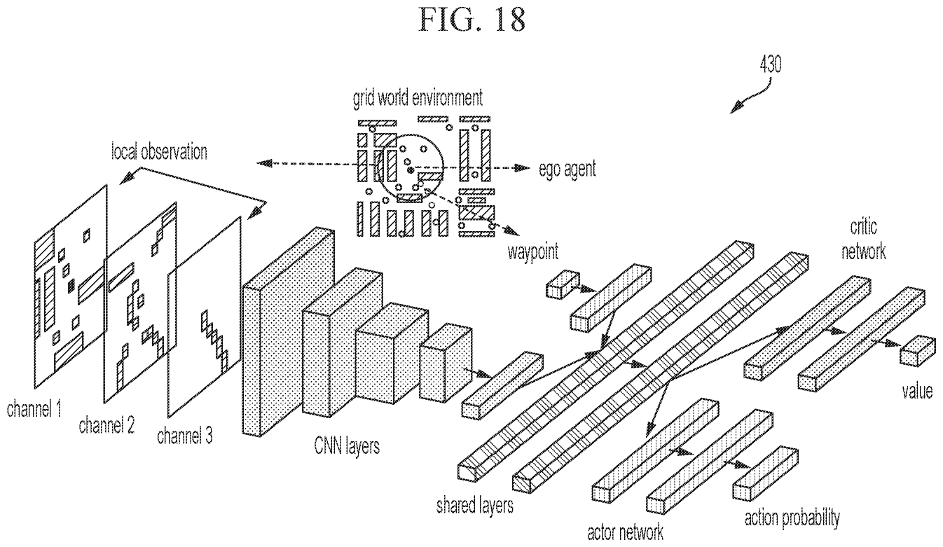

Accordingly, the routing control system 258 executing the process 300 can receive 302 a representation corresponding to the particular configuration of a liquid handler system 250. The representation could include, for example, a grid, such as is shown FIGS. 14 and 18. The routing control system 258 can input 304 the representation to a routing algorithm that is adapted to receiving representations, as opposed to numerical values or other such forms of data, as input. In some embodiments, the routing algorithm could include, for example, a graph search algorithm or a neural network. Accordingly, the routing control system 258 can determine 306 a route for each of the vessel movers 202 associated with the representation and cause 308 the vessel movers 202 to move according to the determined route. In some embodiments, the routing control system 258 could provide control signals to the coil arrays 208 associated with the track system 200 to cause the coil arrays 208 to drive the vessel movers 202 along the track system 200, as generally indicated in FIG. 10.

In one embodiment, the routing control system 258 could dynamically adapt to the presence of additional modules 252 and/or vessel movers 202 (e.g., as modules 252 and/or vessel movers 202 are added to the liquid handler system 250). Accordingly, the routing control system 258 can determine 310 whether any additional modules 252 and/or vessel movers 202 are present. If the control system 258 determines 310 that there are one or more additional modules 252 or vessel movers 202 present, the routing control system 258 can receive 302 or generate an updated representation corresponding to the new configuration of the liquid handler system 250 and continue the process 300 as generally described above.

### Examples

In order to further illustrate the concepts discussed above, various examples are described below. These examples are not to be construed to be limiting in any way; rather, they are simply provided to assist in understanding various embodiments and implementations of the systems and methods described above.

In one illustrative embodiment, the representation could include a grid 400, such as is shown in FIG. 14, and the routing algorithm executed by the routing control system 258 could include a graph search algorithm. In this embodiment, the layout of the track system 200 is discretized as a grid 400 having a defined resolution. In the particular configuration shown in FIG. 14, four vessel movers 202 are shown as circular elements, with corresponding goal locations as the square elements (noting that carrier 2 is already at its location). Vacant cells correspond to the locations of the track system 200.

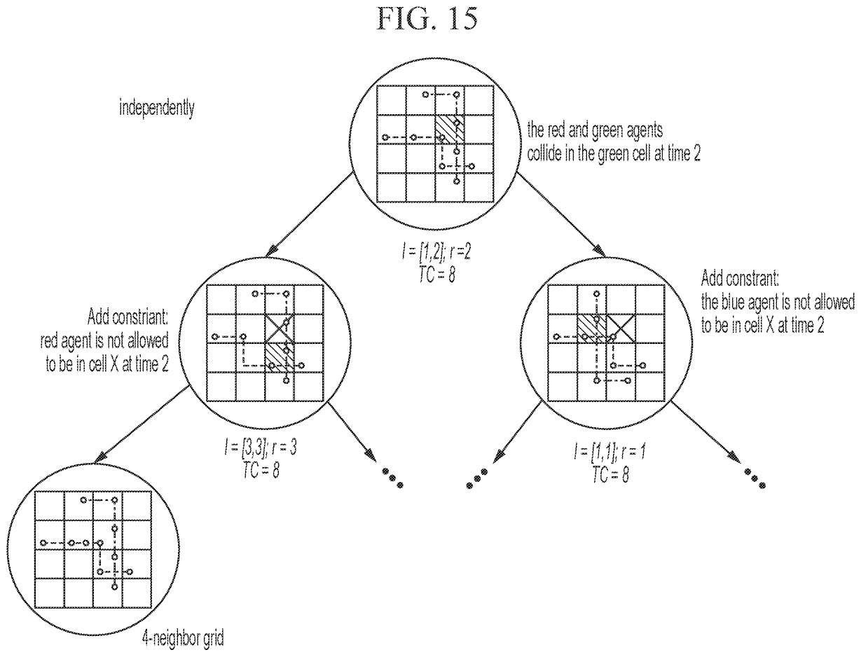

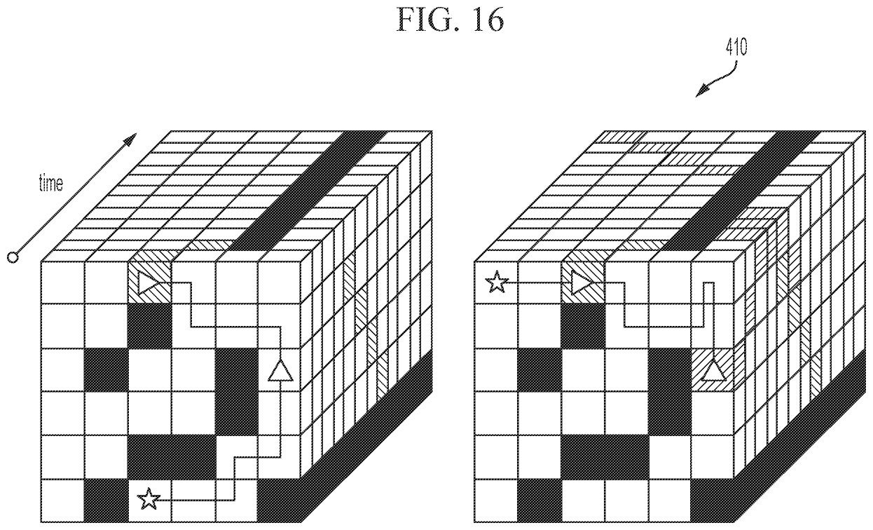

As described above, the coil-driven magnet movement scheme employed by the PCB-based embodiments of the liquid handler system 250 allow for the vessel movers 202 to be moved bi-directionally and independently from each other by controlling which coil arrays are activated, which is a significant difference from conventional conveyor belt-based transport systems (which generally require all or a substantial number of the vessel carriers 202 to be moved in a uniform, unidirectional fashion). By leveraging this independent bi-directional control, the routing control system 258 can intelligently move vessel movers 202 in order to, for example, make way for other vessel carriers 202 as they are moved around the track system 200. Noting the bi-directional movement and independently controllable characteristics for the vessel movers 202 in these embodiments of the liquid handler system 250, there are many possible routes that can be planned for each vessel mover 202 and a variety of different graph search algorithms could be used to plan those routes. In one embodiment, the multi-agent grant search algorithm could include a CBS algorithm. Generally, a CBS algorithm functions by recursively using a low-level search algorithm (e.g., A*) while keeping track of the results at a higher level. FIG. 15, for example, graphically illustrates how a CBS algorithm functions. In particular, single-agent A* searches are performed for each agent. If there is a conflict in the agent paths, the CBS algorithm can mark the conflict cell as an obstacle for one of the agents and run the single-agent A* search again for all agents. Accordingly, the CBS algorithm is able to recursively plan routes for each of the agents (i.e., vessel movers 202) present in the given configuration of the liquid handler system 250.

In another embodiment, although the grid 400 is depicted in FIG. 14 in Cartesian coordinates, the representation utilized by the routing control system 258 could also include a temporal element (i.e., time), which could be treated as another dimension in the route planning process. For example, FIG. 16 illustrates a three-dimensional representation 410 that includes time as the third dimension. In particular, each unit of time could represent one unit of distance in the third dimension. Accordingly, the routing algorithm could find paths for the agents (i.e., vessel carriers 202) in this three-dimension map. In this embodiment, certain moves could be prohibited, such as going back or staying in the same time while changing coordinates.

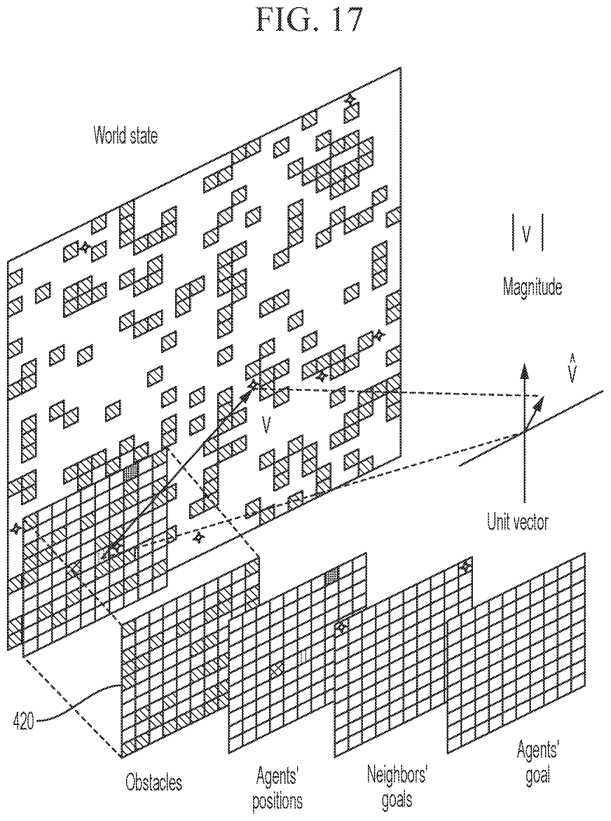

In one illustrative embodiment, the routing algorithm could include a neural network (e.g., a deep neural network). The neural network could be trained via reinforcement learning or other training machine learning training techniques. In this embodiment, the representation could include a local FOV associated with each of the vessel carriers 202 that is provided as input to the neural network. In one embodiment, a policy network may be trained that learns to predict actions for every agent depending on its current state, noting that the definition of “nearby” agents could depends on the FOV associated with each of the agents. In various implementations, the FOV could span the entire map or may be a small radius around each agent to alleviate the computational burden. In one embodiment shown in FIG. 17, the FOV 420 is shown as a 10×10 grid. During the execution of the process 300, the routing control system 258 could feed the FOV 420 into a deep neural network that is trained on simulations to learn what the best possible next step would be (from the discrete action set). In one embodiment, the neural network could include an actor-critic network 430 (FIG. 18) that is trained using a simulation environment. In one implementation, the simulation environment could include simulations of various configurations of liquid handler systems 250 in a reinforced learning-scheme. Once the actor-critic network 430 has been trained, it could be executed by the routing control system 258 during deployment to plan routes for any combination of vessel movers 202, configurations of track systems 200, configurations of modules 252, and so on. Further, because the neural network is not explicitly hardcoded to one or more particular liquid handler system configurations, the routing control system 258 could dynamically adapt to any number of different circumstances.

In sum, the present disclosure describes routing algorithms that can dynamically adapt to a map of a modular analyzer system without requiring any configuration-specific modifications. The dynamic routing techniques described herein are advantageous because the algorithm itself is independent of the configuration (i.e., the algorithm can adapt for a variety of different liquid handler system configurations and does not need to be independently programmed for each configuration). Further, although the present disclosure is primarily described in the context of two-dimensional track systems, the techniques described herein are extendable to three-dimensional tracks since the algorithms described herein are invariant to two or three-dimensions. Furthermore, these planning algorithms can be tuned to particular optimize usage parameters that may be desired by users, including to minimize distance traveled, travel time, vessel mover wear and tear, and so on. This can in turn provide highly efficient and optimized vessel mover routes that are specifically tailored to each user's needs. Finally, a key component of using such a dynamic approach is that the states of all other vessel movers are simultaneously considered while planning the path, and other vessel movers may even be issued move commands to fulfill the planned path. This ensures all samples reach their desired destinations just in time (JIT) while avoiding collisions.

While various illustrative embodiments incorporating the principles of the present teachings have been disclosed, the present teachings are not limited to the disclosed embodiments. Instead, this application is intended to cover any variations, uses, or adaptations of the present teachings and use its general principles. Further, this application is intended to cover such departures from the present disclosure that are within known or customary practice in the art to which these teachings pertain.

In the above detailed description, reference is made to the accompanying drawings, which form a part hereof. In the drawings, similar symbols typically identify similar components, unless context dictates otherwise. The illustrative embodiments described in the present disclosure are not meant to be limiting. Other embodiments may be used, and other changes may be made, without departing from the spirit or scope of the subject matter presented herein. It will be readily understood that various features of the present disclosure, as generally described herein, and illustrated in the Figures, can be arranged, substituted, combined, separated, and designed in a wide variety of different configurations, all of which are explicitly contemplated herein.

A second action can be said to be “in response to” a first action independent of whether the second action results directly or indirectly from the first action. The second action can occur at a substantially later time than the first action and still be in response to the first action. Similarly, the second action can be said to be in response to the first action even if intervening actions take place between the first action and the second action, and even if one or more of the intervening actions directly cause the second action to be performed. For example, a second action can be in response to a first action if the first action sets a flag and a third action later initiates the second action whenever the flag is set.

The present disclosure is not to be limited in terms of the particular embodiments described in this application, which are intended as illustrations of various features. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein are generally intended as “open” terms (for example, the term “including” should be interpreted as “including but not limited to,” the term “having” should be interpreted as “having at least,” the term “includes” should be interpreted as “includes but is not limited to,” et cetera). While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention.

In addition, even if a specific number is explicitly recited, those skilled in the art will recognize that such recitation should be interpreted to mean at least the recited number (for example, the bare recitation of “two recitations,” without other modifiers, means at least two recitations, or two or more recitations). Furthermore, in those instances where a convention analogous to “at least one of A, B, and C, et cetera” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, et cetera). In those instances where a convention analogous to “at least one of A, B, or C, et cetera” is used, in general such a construction is intended in the sense one having skill in the art would understand the convention (for example, “a system having at least one of A, B, or C” would include but not be limited to systems that have A alone, B alone, C alone, A and B together, A and C together, B and C together, and/or A, B, and C together, et cetera). It will be further understood by those within the art that virtually any disjunctive word and/or phrase presenting two or more alternative terms, whether in the description, sample embodiments, or drawings, should be understood to contemplate the possibilities of including one of the terms, either of the terms, or both terms. For example, the phrase “A or B” will be understood to include the possibilities of “A” or “B” or “A and B.”

In addition, where features of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, et cetera. As a non-limiting example, each range discussed herein can be readily broken down into a lower third, middle third and upper third, et cetera. As will also be understood by one skilled in the art all language such as “up to,” “at least,” and the like include the number recited and refer to ranges that can be subsequently broken down into subranges as discussed above. Finally, as will be understood by one skilled in the art, a range includes each individual member. Thus, for example, a group having 1-3 components refers to groups having 1, 2, or 3 components. Similarly, a group having 1-5 components refers to groups having 1, 2, 3, 4, or 5 components, and so forth.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

1. A liquid handler system for processing a liquid sample, the liquid handler system comprising:
one or more modules configured to process the liquid sample;
a track system interconnecting the one or more modules, the track system configured to support one or more vessel movers thereon, the one or more vessel movers comprising a magnet and configured to receive the liquid sample; and
a routing control system configured to:
receive a representation corresponding to a configuration of the one or more modules and the one or more vessel movers associated with the liquid handler system,
determine, using the routing algorithm, a route for each of the one or more vessel movers based on the representation, and
cause the one or more vessel movers to move along the track system between the one or more modules according to the determined route for each of the one or more vessel movers.

2. The liquid handler system of claim 1, wherein the routing control system is further configured to:
determine whether any additional modules or vessel movers are associated with the liquid handler system;
receive an updated representation corresponding to an updated configuration of the one or more modules, the one or more vessel movers, and any additional modules or vessel movers associated with the liquid handler system;
determine, using the routing algorithm, an updated route for each of the one or more vessel movers based on the updated representation; and
cause the one or more vessel movers and the additional vessel movers to move along the track system between the one or more modules and the additional modules according to the determined updated route for each of the one or more vessel movers and the additional vessel movers.

3. The liquid handler system of claim 1, wherein the representation comprises a grid.

4. The liquid handler system of claim 3, wherein the grid graphically indicates locations of the track system, the one or more modules, and the one or more vessel movers.

5. The liquid handle system of claim 1, wherein the routing control system comprises a neural network.

6. The liquid handler system of claim 5, wherein the neural network comprises an actor-critic network.

7. The liquid handler system of claim 1, wherein the routing control system executes a graph search algorithm.

8. The liquid handler system of claim 7, wherein the graph search algorithm comprises a conflict-based search (CBS) algorithm.

9. A method of routing one or more vessel carriers associated with a liquid handler system configured to process a liquid sample, the liquid handler system comprising one or more modules configured to process the liquid sample and a track system interconnecting the one or more modules and configured to support the one or more vessel movers thereon, the one or more vessel movers comprising a magnet and configured to receive the liquid sample, the method comprising:
receiving, by a routing control system, a representation corresponding to a configuration of the one or more modules and the one or more vessel movers associated with the liquid handler system,
determining, by the routing control system using the routing algorithm, a route for each of the one or more vessel movers based on the representation, and
causing, by the routing control system, the one or more vessel movers to move along the track system between the one or more modules according to the determined route for each of the one or more vessel movers.

10. The method of claim 9, further comprising:
determining, by the routing control system, whether any additional modules or vessel movers are associated with the liquid handler system;
receiving, by the routing control system, an updated representation corresponding to an updated configuration of the one or more modules, the one or more vessel movers, and any additional modules or vessel movers associated with the liquid handler system;
determining, by the routing control system using the routing algorithm, an updated route for each of the one or more vessel movers based on the updated representation; and
causing, by the routing control system, the one or more vessel movers and the additional vessel movers to move along the track system between the one or more modules and the additional modules according to the determined updated route for each of the one or more vessel movers and the additional vessel movers.

11. The method of claim 9, wherein the representation comprises a grid.

12. The method of claim 11, wherein the grid graphically indicates locations of the track system, the one or more modules, and the one or more vessel movers.

13. The method of claim 9, wherein the routing control system comprises a neural network.

14. The method of claim 13, wherein the neural network comprises an actor-critic network.

15. The method of claim 9, wherein the routing control system executes a graph search algorithm.

16. The method of claim 15, wherein the graph search algorithm comprises a conflict-based search (CBS) algorithm.
